(19) United States
(12) Patent Application Publication
(10) Pub. No.: US 2003/0006396 A1
(43) Pub. Date: Jan. 9, 2003

(54) Polishing composition for CMP having abrasive particles

(76) Inventors: Hongyu Wang, Wilmington, DE (US); Terence M. Thomas, Newark, DE (US); Qianqiu Ye, Wilmington, DE (US); Heinz F. Reinhardt, Chadds Ford, PA (US); Vikas Sachan, Richardson, TX (US)

Correspondence Address: Rodel Holdings, Inc., Suite 1300, 1105 North Market Street, Wilmington, DE, 19899, US

(21) Appl. No.: 10/159,383

(22) Filed: May 31, 2002

Related U.S. Application Data
(63) Continuation-in-part of application No. 09/883,472, filed on Jun. 18, 2001.
(63) Continuation-in-part of application No. 09/734,087, filed on Dec. 11, 2000.
(60) Provisional application No. 60/170,612, filed on Dec. 14, 1999.
(60) Provisional application No. 60/171,553, filed on Dec. 22, 1999.
(60) Provisional application No. 60/295,205, filed on Jun. 1, 2001.

(51) Int. Cl. C09K 3/14; C09C 1/68

(52) U.S. Cl. 252/79.1; 51/309

(57) ABSTRACT

A polishing composition for CMP to remove a noble metal has a substance forming ligands with the noble metal for dissolution in the polishing composition, abrasive particles, and a surfactant comprising a dispersant of the abrasive particles to minimize formation of agglomerates of the abrasive particles, the abrasive particles being coated by the surfactant to provide surfactant coated abrasive particles that minimize scratching of a surface being abraded by the surfactant coated abrasive particles during CMP.

### CROSS REFERENCE TO RELATED APPLICATIONS

This application claims the benefit of provisional application No. 60/295,205, filed Jun. 1, 2001.

This application is a continuation in part of application Ser. No. 09/734,087, filed Dec. 11, 2000, which claims the benefit of provisional application No. 60/170,612, filed Dec. 14, 1999, and provisional application No. 60/171,553, filed Dec. 22, 1999.

This application is a continuation in part of application Ser. No. 09/883,472, filed Jun. 18, 2001.

### FIELD OF THE INVENTION

The invention relates to a polishing composition for CMP, the polishing composition having abrasive particles.

### BACKGROUND

CMP refers to chemical mechanical planarization, a process of polishing a workpiece with a moving polishing pad and a fluid polishing composition. A layer of material at the surface of the workpiece is removed by chemically reacting with the polishing composition to provide products of chemical reaction, while the polishing pad applies abrasion to remove the products of chemical reaction at a predictable rate of removal. To apply further abrasion, the fluid polishing composition is provided with dispersed abrasive particles in fluid suspension. During CMP, the layer of material is polished to a planar polished surface. The layer of material is referred to as being a planarized layer. Polishing of the planarized layer continues until the planarized layer is completely removed from an underlying material. Further, the polishing process polishes the underlying material with a smooth, planar polished surface to provide a planarized substrate on which successive layers of materials are constructed to form elements of semiconductor circuit devices.

When CMP is performed to remove a layer of a noble metal, for example, platinum, relatively low chemical reactivity of the noble metal with the polishing composition contributes to relatively slow removal of the noble metal. To quicken the removal of the noble metal, the polishing composition relies upon abrasive particles in fluid suspension to apply sufficient abrasion to remove the noble metal by abrasion. However, the abrasive particles tend to scratch the surface being polished and abraded by the abrasive particles, especially when the abrasive particles agglomerate to form larger particles that further tend to scratch the surface being abraded. Scratches comprise undesired increases in step height in the planarized surface. Scratches further comprise defects in the smooth, planar polished surface. The problem to be solved is to remove a noble metal by CMP using abrasive particles, while minimizing scratches in the surface being abraded by the abrasive particles.

U.S. Pat. No. 6,027,554 discloses a polishing composition for CMP having an oxidizer, or oxidizing agent, of a metal to be polished and removed by CMP, and further having abrasive particles, together with an acid as a dispersant of the particles. The metal being polished is oxidized by the oxidizer, and a polishing pad and the abrasive particles remove the products of oxidation for dissolution in the polishing composition.

### SUMMARY OF THE INVENTION

The invention provides a polishing composition for CMP of a noble metal. A surfactant in the polishing composition bonds with abrasive particles in the polishing composition to provide surfactant coated abrasive particles that apply abrasion to remove a noble metal by CMP, and the surfactant comprises a dispersing agent that minimizes agglomeration of the surfactant coated abrasive particles, which minimizes scratches in a surface being abraded by the surfactant coated abrasive particles.

According to an embodiment, a concentration of the surfactant is directly proportional to a concentration of abrasive particles to be coated by the surfactant to provide surfactant coated abrasive particles in a polishing composition for CMP.

According to a further embodiment, the surfactant comprises sulfonated naphthalene, and abrasive particles in a polishing composition for CMP are coated by the surfactant.

Embodiments of the invention will now be described by way of example with reference to the accompanying detailed description.

### DETAILED DESCRIPTION

A surfactant forms molecular coatings by absorption on the respective surfaces of the abrasive particles in the polishing composition. In an embodiment, each molecular coating is a monolayer formed on the surface of a corresponding abrasive particle by absorption. Further, the surfactant comprises a dispersing agent, or dispersant, of the abrasive particles. The surfactant comprising a dispersing agent is absorbed on the surfaces of the abrasive particles, and minimizes agglomeration of the particles with one another to maintain a substantially uniform dispersion of the particles throughout the fluid polishing composition. The surfactant comprising a dispersing agent that is absorbed on the surfaces of the abrasive particles minimizes larger particles formed as agglomerates of the abrasive particles.

The abrasive particles have sharp points of contact that become coated with the surfactant. During CMP, forces applied by the coated abrasive particles against the surface being polished will become distributed over the surfactant coated points of contact, which reduces the force per unit area applied by the surfactant coated points of contact, as compared to that applied by uncoated points of contact, and minimizes scratches applied to the surface being abraded by the coated abrasive particles during CMP. Further, the surfactant comprising a dispersing agent minimizes agglomeration of relatively small dispersed abrasive particles. Larger abrasive particles form as agglomerates of the relatively small particles. During CMP, a polishing pad would urge larger particles, the agglomerates, against the surface being polished at higher force than smaller dispersed particles, causing the larger particles to apply further scratches to the surface being polished. The surfactant minimizes agglomeration of the abrasive particles that would tend to form larger particles that, in turn, would apply scratches to a surface being polished during CMP.

### EXAMPLES

Platinum-containing wafers were polished utilizing polishing compositions I and II. The results are recorded in Table 1.

Polishing composition I comprised: 1% alpha-alumina abrasive particles; 0.2% citric acid; 0.2% sodium thiosulfate; and 1% aluminum nitrate. All percentages are on a weight basis. The remaining weight of I comprised water. The pH of composition I was adjusted to 2.0 utilizing hydrochloric acid. Without a surfactant in the polishing composition, the abrasive particles of 130 nm., nanometers, average size, agglomerated to form agglomerates of 900 nm. average size. Sodium thiosulphate is a substance providing sulfur containing ions as ligands bonded to the noble metal, for dissolution in the polishing composition I or II, which contributes to removal of the noble metal during CMP without the use of an oxidizing agent, or an oxidizer, of the noble metal. Aluminum nitrate adds aluminum ions corresponding to the solubility limit of aluminum ions at pH 2, which provides an environment of equilibrium dissolution for the alumina particles, at a stabilized pH 2. Citric acid decreases dissolution of silicon dioxide into the polishing composition at a pH 2 as adjusted by hydrochloric acid. For example, when a noble metal is removed from an underlying insulating layer of silicon dioxide by CMP, a decrease in the dissolution of silicon dioxide during CMP is desired. Further details of the polishing composition for CMP of a noble metal are incorporated herein by reference to U.S. Ser. No. 09/734,087, filed Dec. 11, 2000.

An example of a surfactant comprising a dispersing agent is sulfonated naphthalene, which was dissolved in the polishing composition at a concentration that varies directly with the variation of the concentration of the abrasive particles to be coated by the sulfonated naphthalene, to form a corresponding concentration of surfactant coated abrasive particles. Increasing the concentration of the abrasive particles will increase the abrasion applied by the abrasive particles, and will increase the rate of removal of the noble metal during CMP. Too high a concentration of abrasive particles produces heavily applied abrasion, causing defects in planarization and defects in the smooth, planar polished surface. Conversely, decreasing the concentration of the abrasive particles will decrease the rate of removal of the noble metal during CMP. Too low a concentration of abrasive particles will slow the rate of removal of the noble metal, and will increase the time required for CMP beyond economically acceptable limits. To assure uniform coating of the abrasive particles, the surfactant comprising a dispersing agent is dissolved in the polishing composition at a concentration that varies directly with a corresponding variation in the concentration of the abrasive particles to be coated. For correspondence with a particle concentration of 1% alpha alumina, a corresponding concentration of 0.1% sulphonated naphthalene, LOMAR™, manufactured by Henkel Chemical Company, was dissolved in the polishing compositions 1 and 11 to comprise a surfactant comprising a dispersing agent. The addition of LOMAR™ dissolved in the polishing composition, formed surfactant coated abrasive particles that remained dispersed in the polishing composition, and minimized formation of agglomerates.

Polishing composition II comprised: 1% alpha-alumina; 0.2% citric acid; 0.3% sodium thiosulfate; and 1% aluminum nitrate. The remaining weight of II comprised water. The pH of II was adjusted to 2.0 utilizing hydrochloric acid. Without a surfactant in the polishing composition, the abrasive particles of 130 nm., nanometers, average size, agglomerated to form agglomerates of 1700 nm. average size.

The addition of LOMAR™ dissolved in the polishing composition II, formed surfactant coated abrasive particles that remained dispersed in the polishing composition II, and minimized formation of agglomerates.

TABLE 1

| | I without | I with | II without | II with |
|---|---|---|---|---|
| | LOMAR ™ | LOMAR ™ | LOMAR ™ | LOMAR ™ |
| Metric | surfactant | surfactant | surfactant | surfactant |
| Ra (nm) | 0.191 | 0.074 | 0.286 | 0.071 |
| Rq (nm) | 0.266 | 0.106 | 0.381 | 0.101 |

Atomic force microscopy (AFM) scans were taken to provide the surface characteristics recorded in Table 1, of platinum wafers polished with II and I (with and without LOMAR™ surfactant). A Digital Instruments Dimension 5000 Atomic Force Microscope was utilized for all wafer surface characterizations employing a 20 micron by 20 micron scan area.

Table 1 indicates, wafers polished by CMP with polishing compositions containing LOMAR™ surfactant had substantially lower average roughness (Ra) and root mean square roughness (Rq) compared to wafers polished with polishing compositions without LOMAR™ surfactant. The scratches in wafers polished with polishing compositions without the surfactant had an average scratch width of 0.313 nm and an average scratch depth of 0.792 nm.

The abrasive particles of polishing compositions I and II comprise alpha alumina, and alternatively comprise, but are not limited to; ceria, diamond, germania, magnesium oxide, silica, titania, zirconia, silicon carbide, boron carbide, boron nitride, and combinations thereof.

What is claimed is:

1. A polishing composition for CMP to remove a noble metal, comprising: a substance forming ligands with the noble metal for dissolution in the polishing composition, which contributes to removal of the noble metal during CMP without the use of an oxidizing agent of the noble metal, water, abrasive particles in an environment of equilibrium dissolution thereof, a pH adjuster providing an adjusted pH, and a surfactant comprising a dispersant of the abrasive particles to minimize formation of agglomerates of the abrasive particles, the abrasive particles being coated by the surfactant to provide surfactant coated abrasive particles that minimize scratching of a surface being abraded by the surfactant coated abrasive particles during CMP, and a concentration of the surfactant being directly proportional to a corresponding concentration of the abrasive particles to assure coating of the abrasive particles with the surfactant.

2. The polishing composition as recited in claim 1 wherein, sodium thiosulfate comprises the substance forming ligands with the noble metal for dissolution in the polishing composition without an oxidizer of the noble metal.

3. The polishing composition as recited in claim 1 wherein, the abrasive particles comprise alpha alumina in an environment of equilibrium dissolution thereof as provided by aluminum nitrate contributing aluminum ions at the solubility limit at said adjusted pH.

4. The polishing composition as recited in claim 1 wherein, the surfactant is sulfonated naphthalene.

5. The polishing composition as recited in claim 1, further comprising: citric acid to retard dissolution of an insulating layer from which the noble metal is removed by CMP.

6. The polishing composition as recited in claim 5 wherein, sodium thiosulfate comprises the substance forming ligands with the noble metal for dissolution in the polishing composition without an oxidizer of the noble metal.

7. The polishing composition as recited in claim 5 wherein, the abrasive particles comprise alpha alumina in an environment of equilibrium dissolution thereof as provided by aluminum nitrate contributing aluminum ions at the solubility limit at said adjusted pH.

8. The polishing composition as recited in claim 5 wherein, the surfactant is sulfonated naphthalene.

9. A method of removing a noble metal by CMP, comprising the steps of:
providing a polishing composition with abrasive particles and a surfactant,
coating the abrasive particles with a surfactant to provide surfactant coated abrasive particles to minimize scratches applied to a surface being abraded by the surfactant coated abrasive particles during CMP, and
polishing the noble metal with a polishing pad and the polishing composition.

10. The method as recited in claim 9 wherein, sodium thiosulfate comprises the substance forming ligands with the noble metal for dissolution in the polishing composition without an oxidizer of the noble metal.

11. The method as recited in claim 9 wherein, the abrasive particles comprise alpha alumina in an environment of equilibrium dissolution thereof as provided by aluminum nitrate contributing aluminum ions at the solubility limit at said adjusted pH.

12. The method as recited in claim 9 wherein, the surfactant is sulfonated naphthalene.

13. The method as recited in claim 9, further comprising: retarding dissolution of an insulating layer from which the noble metal is removed by CMP.

14. The method as recited in claim 13 wherein, sodium thiosulfate comprises the substance forming ligands with the noble metal for dissolution in the polishing composition without an oxidizer of the noble metal.

15. The method as recited in claim 13 wherein, the abrasive particles comprise alpha alumina in an environment of equilibrium dissolution thereof as provided by aluminum nitrate contributing aluminum ions at the solubility limit at said adjusted pH.

16. The method as recited in claim 13 wherein, the surfactant is sulfonated naphthalene.
